(19) United States
(12) Patent Application Publication
(10) Pub. No.: US 2016/0214448 A1
(43) Pub. Date: Jul. 28, 2016

(54) TYRE-CHANGING MACHINE

(71) Applicant: SICAM S.R.L., Correggio (IT)

(72) Inventors: Bjoern Dressler, Correggio (IT); Marco Vescovini, Correggio (IT); Alessandro Gilocchi, Correggio (IT)

(21) Appl. No.: 15/026,218

(22) PCT Filed: Sep. 29, 2014
(86) PCT No.: PCT/IB2014/064916

§ 371 Date: Mar. 30, 2016

(30) Foreign Application Priority Data
Sep. 30, 2013 (IT) MO2013A000274

(51) Int. Cl. B60C 25/138; B60C 25/05

(52) U.S. Cl. CPC B60C 25/138; B60C 25/0545; B60C 25/0539

(57) ABSTRACT

The tyre-changing machine comprises: a base structure which can rest on the ground; a gripping and rotation unit, suitable for gripping the rim of a wheel and placing it in rotation, mounted on a front part of the structure; a supporting post, arranged at the rear of the unit, connected to the structure by means of a hinge arranged in correspondence to a front part of the post facing the unit, the post being rotatable around the hinge between a work position, wherein it is closer to the unit, and a disengagement position, wherein it is tilted to the rear and is farther from the unit; and a tool-carrying arm fitted on the post suitable for carrying a tool to fit/remove a tyre onto/from the rim.

### TECHNICAL FIELD

The present invention relates to a tyre-changing machine.

### BACKGROUND ART

The use is known of tyre-changing machines for the removal and fitting of a tyre from the relative rim to repair or replace the tyre itself.

A known type of machine comprises a base having a wheel gripping and rotation unit, a supporting post positioned upright from the base and a tool-carrying arm mounted on the post and suitable for moving vertically and horizontally.

The arm bears a tool for removing or fitting the tyre.

The removal tool is suitable for gripping the bead of the tyre to raise and remove it above an annular flange of the rim.

In use, after a preliminary tyre bead breaking phase, an operator positions and locks the wheel on the gripping and rotation means.

The tool is then moved towards the wheel, until it abuts and presses the side of the tyre, introducing one of its extremities, usually hooked, between the tyre bead and the rim.

Subsequently, the tool is moved so as to extract from the rim the portion of bead involved by the tool.

At this point, the rim is made to rotate by the above unit, to allow the entire bead to come out of the rim itself.

After which, the unit stops and the operator unloads the removed tyre and then loads another one to fit it on the rim.

After fitting, the wheel complete with the new tyre is in turn unloaded by the operator.

During the loading and unloading operations, the arm that carries the tool must be moved away from the work area in correspondence to the gripping and rotation unit, so as not to hinder the work of the operator.

For this purpose, some types of tyre-changing machines have a tip-up supporting post.

In practice, the post is suitable for tilting as it moves away from the gripping and rotation unit, i.e., behind the machine, considering the unit is positioned in the front part of the machine.

In detail, the post can oscillate between a work position wherein the post is vertical and the tool-carrying arm surmounts the unit, and can therefore intervene on the rim and tyre, and a disengagement position wherein it is tilted backwards to free the above work area.

The known oscillating or tip-up posts have a rear hinge, with horizontal axis, whereby they are connected to the aforementioned base.

More precisely, such hinge is positioned in correspondence to the side of the post opposite the one facing the gripping and rotation unit.

Furthermore, a linear actuator is positioned in front of the post with the cylinder hinged to the base and the rod hinged to the post itself.

The operation of the actuator determines the oscillation of the post.

In detail, when the post is in work position, the actuator is operated so as to retain the post vertically, pulling it towards the base.

In fact, in use, the post undergoes considerable stresses during the tyre removal and fitting operation, during which the tool carried by the arm connected to the post works in correspondence to the rim operated in rotation by the above unit.

In practice, the forces at play propagate from the rim in rotation to the tool and from here to the arm, and then to the post.

The transfer of the stresses from the post to the base occurs in correspondence to the hinge, such stresses then passing from the base to the gripping and rotation unit which carries the rim, to define a sort of ample chain of forces.

The bending moments produced by the stresses in correspondence to the arm and the post, and in particular to the hinge, make it necessary to use a linear actuator with a high performance, which as is well known, is expensive.

Furthermore, strong bending moments are also produced in correspondence to the annular flange defining the bead seat in the rim and which is involved in the action of the fitting tool.

Such moments can result in damage being caused to the rim.

### DESCRIPTION OF THE INVENTION

The main aim of the present invention is to provide a tyre-changing machine wherein, during use, the bending moments acting in correspondence to the post hinge and in correspondence to the rim are less than those of prior art.

Another object of the present invention is to provide a tyre-changing machine which can overcome the above mentioned drawbacks of the prior art in the ambit of a simple, rational, easy and effective to use as well as affordable solution.

The above mentioned objects are achieved by the present tyre-changing machine made according to claim 1.

### BRIEF DESCRIPTION OF THE DRAWINGS

Other characteristics and advantages of the present invention will become better evident from the description of a preferred, but not exclusive, embodiment of a tyre-changing machine, illustrated by way of an indicative, but not limitative example in the accompanying drawings in which:

FIG. 1 is a vertical sectional view of the tyre-changing machine according to the invention, in one of its operative configurations, in which are schematically shown the chains of the forces of the prior art and the invention;

FIG. 2 is a view of the preceding illustration, in which the machine is shown in a different operative configuration; and

FIG. 3 is an axonometric view of the machine according to the invention, the base structure of which is partially open.

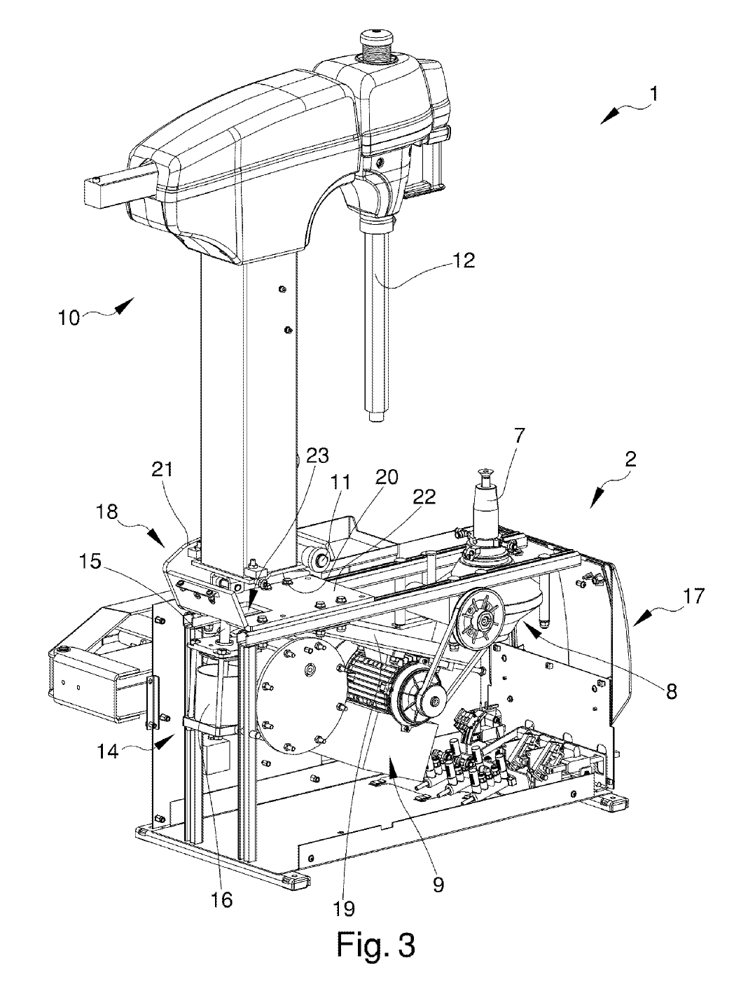

### EMBODIMENTS OF THE INVENTION

With special reference to these figures, globally indicated by 1 is a tyre-changing machine of the invention.

The proposed machine 1 first of all comprises a base structure 2 which can rest on the ground and a gripping and rotation unit 3, suitable for gripping the rim 4 of a wheel 4, 5 and placing it in rotation, mounted on a front part of the structure 2 itself.

In detail, the gripping and rotation unit 3 comprises a chuck, in the form of a self-centring plate 6 which takes the wheel 4, 5, which plate 6 is placed in rotation by a central shaft 7 which protrudes from the top of the structure 2.

The shaft 7 is rotated by a gear motor 8, positioned in an internal volume of the above structure 2.

A specific motor 9, it too included in such internal volume, operates the gear motor 8 and, consequently, the plate 6.

The machine 1 also comprises a supporting post 10, arranged at the rear of the gripping unit 3, which is connected to the structure 2 by means of a hinge 11 with horizontal rotation axis, arranged in correspondence to the bottom of post 10.

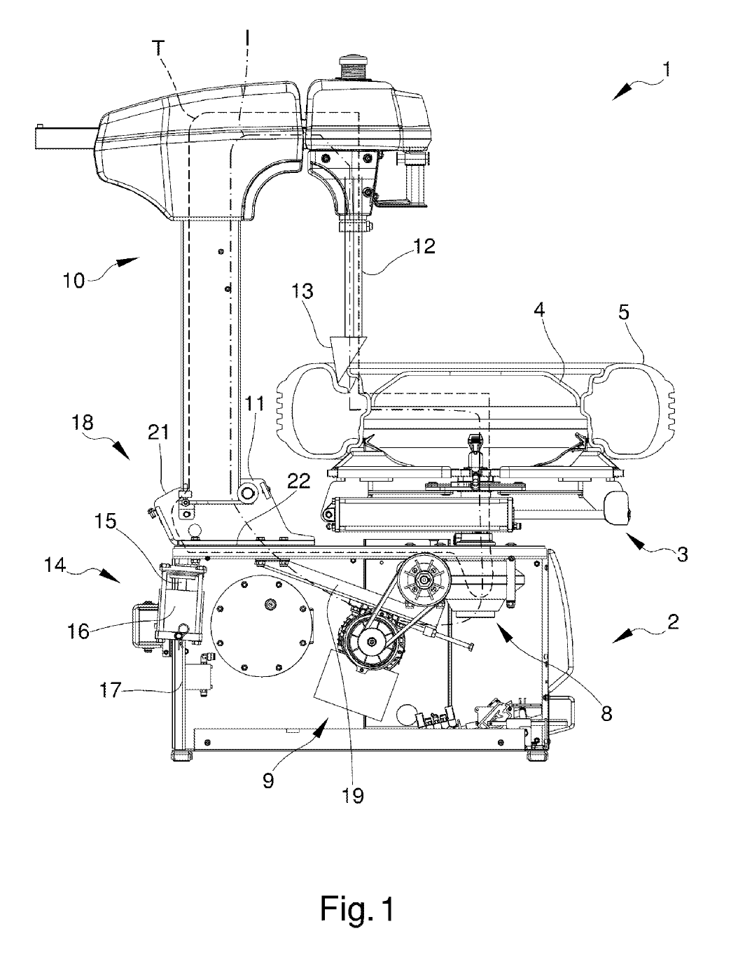

The invention then includes a tool-carrying arm 12 fitted on the post 10 and suitable for carrying a tool 13 (shown in stylized form in the FIG. 1) to fit/remove a tyre 5 onto/from the rim 4 of a wheel 4, 5 gripped by the aforementioned self-centring plate 6.

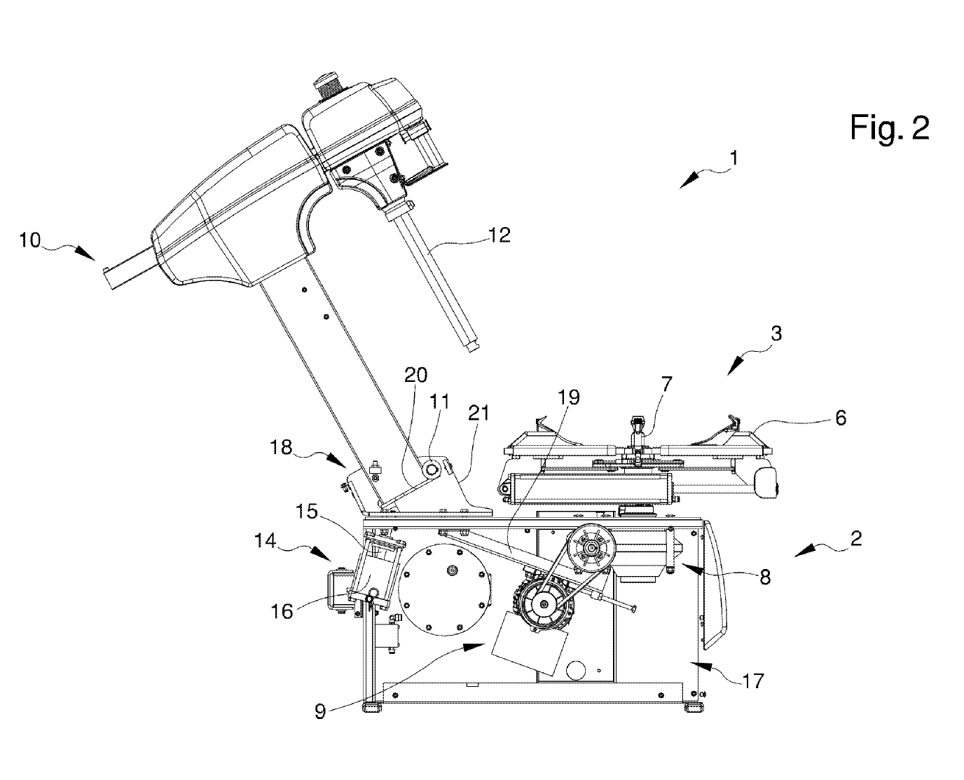

The post 10 is of the tip-up type and is rotatable with respect to the above hinge 11 so as to be able to oscillate between a work position (see FIG. 1), wherein it is closer to the gripping unit 3, and a disengagement position, wherein it is tilted to the rear and is farther from the unit 3 (see FIG. 2).

In practice, in the work position, the post 10 is arranged vertically, and the tool-carrying arm 12, which surmounts the unit 3, can be moved towards the wheel 4, 5 so the aforementioned tool 13 can engage with the wheel 4, 5, between the rim 4 and the tyre 5, so as to remove the latter.

In detail, the gripping unit 3 and the tool 13 cooperate in a known way to perform the fitting/removal operations of tyre 5.

When the operator has to load/unload a wheel 4, 5 or a rim 4, before or after a fitting or removal operation, the post 10 is tilted to the rear, and therefore towards the back of the machine, causing it to rotate around its hinge 11.

This way, the work area is freed in correspondence to the gripping unit 3.

Clearly, when the tool 13 has to be used, the post 10 is returned to its vertical work position.

The oscillation between the two operating positions of post 10 is performed by actuation means 14 connected to the post 10, preferably comprising a hydraulic cylinder.

The cylinder 14 comprises a rod 15 the extremity of which is hinged to the post 10, while the barrel 16 is hinged to the aforementioned base structure 2.

According to a very important aspect of the invention, the hinge 11 of the post 10 is positioned in correspondence to a front part of the post 10 itself, facing the aforementioned gripping unit 3.

The actuation means 14 intervene on the post 10 from the opposite side with respect to the hinge 11, and the rod 15 of the cylinder is hinged to the rear part of the post 10.

This solution permits bringing the point of rotation of post 10 closer to the tool 13 on which the stresses of rim 4 are discharged, and to the shaft 7 which causes the rotation of the rim 4 itself.

Consequently, the arm of the bending moment having as pole the hinge 11, is reduced compared to that of prior art, with the consequence that the bending moment module acting on the machine of the invention is lower than that undergone by prior art.

We shall come back to this aspect later on after illustrating further construction aspects of the invention.

In the preferred embodiment of the invention, the structure 2 comprises a platform 17 resting directly on the ground and a counter frame 18, 19, fixed to the platform 17 and supported by it.

The counter frame 18, 19 is mechanically connected to the post 10 by means of the hinge 11 and is also mechanically connected to the gripping unit 3.

In detail, the counter frame 18, 19 preferably comprises a rear part 18 supported directly by the platform 17, in correspondence to which is arranged the hinge 11, and a front part 19, preferably plate shaped, which connects stiffly the rear part 18 to the gripping unit 3.

More precisely, the front part 19 of the counter frame 18, 19 is arranged inside the platform 17 and, preferably, supports the motor 9 which operates the unit 3, connected to the gear motor 8 by means of pulleys and belts or similar drive means.

Still more in detail, the front part 19 of the counter frame 18, 19 is connected to the bottom of the gear motor 8.

In practice, the rear part 18 of the counter frame 18, 19 is arranged above the platform 17, in correspondence to its rear, while the front part 19 is tilted so as to connect the rear part 18 to the bottom of the gear motor 8.

FIG. 1 shows the comparison between the paths T, I of the chains of the forces that stress the machine in prior art and in the invention.

The path T of the prior art starts from the shaft 7, passes through the tool 13, the arm 12, the rear part 18 of the supporting post 10, and then bends by almost ninety degrees and longitudinally crosses the base of the known machine to reach the gear motor 8, in correspondence to which it makes an inversion before reaching the shaft 7, closing the circuit.

In the invention instead, the chain of the forces runs along the front part 19 of the post 10, where the hinge 11 is arranged and then, by means of the passage in the rear part 18 of the counter frame 18, 19, discharges along its tilted front part 19 before returning up through the gear motor 8 as far as the shaft 7.

In practice, the invention defines a narrower chain of forces without any sudden bends to define a G-shaped path I, so the structure 2, and in particular the post 10, the rim 4 and the tool 13, undergo a lower-module bending moment.

This permits using actuation means 14 of smaller sizing and, at the same time, reducing the risk of damaging the rim 4.

Preferably, the rear part 18 of the counter frame 18, 19 is box-shaped, to define an inner volume in which the base 20, or bottom, of the post 10 moves freely while it shifts from the work position to the disengagement position and vice versa.

Such rear part 18 can be defined by a pair of side plates 21 facing one another, between which is arranged the hinge 11 and the base of the post 10.

The side plates 21 are joined below by a base plate 22 fastened to the platform 17.

Preferably, the rear part 18 comprises, in correspondence to the base plate 22, a passage 23 crossed with sliding freedom by the rod 15 of the above actuator.

1. Tyre-changing machine comprising: a base structure which can rest on the ground; a gripping and rotation unit, suitable for gripping the rim of a wheel and placing it in rotation, mounted on a front part of said structure; a supporting post, arranged at the rear of said unit, connected to said structure by means of a hinge, said post being rotatable around said hinge between a work position, wherein it is closer to said unit, and a disengagement position wherein it is tilted to the rear and is farther from said unit; and a tool-carrying arm fitted on said post suitable for carrying a tool to fit/remove a tyre onto/from said rim; wherein said hinge is arranged in correspondence to a front part of said post, facing said unit.

2. Machine according to claim 1, wherein said machine comprises actuation means suitable for moving said post between said work position and disengagement position, connected to said post in correspondence to one of its rear parts opposite said front part.

3. Machine according to claim 2, wherein said actuation means comprise at least a hydraulic cylinder comprising a rod hinged to said rear part and a barrel hinged to said base structure.

4. Machine according to claim 1, wherein said structure comprises a platform suitable for resting directly on the ground and a counter frame, fixed to said platform, said counter frame being mechanically connected both to said post, by means of said hinge, and to said unit.

5. Machine according to claim 4, said counter frame comprises a rear part (18), in correspondence to which is arranged said hinge, and a front part which connects stiffly said rear part to said unit.

6. Machine according to claim 5, wherein said front part of the counter frame is arranged inside said platform.

7. Machine according to claim 5, wherein said front part of the counter frame supports a motor for the operation of said unit.

8. Machine according to claim 5, wherein said front part of the counter frame is connected to the bottom of said unit.

9. Machine according to claim 5, wherein said rear part of the counter frame is box shaped to define an inner volume in which the base of the post moves freely, while it shifts from the work position to the disengagement position or vice versa.

10. Machine according to claim 9, wherein said rear part comprises a passage crossed with sliding freedom by the rod of a linear actuator, comprised in said actuation means and hinged in correspondence to said rear part of the post.
